(19) United States
(12) Patent Application Publication
(10) Pub. No.: US 2009/0204453 A1
(43) Pub. Date: Aug. 13, 2009

(54) AIRCRAFT FLIGHT PLAN OPTIMIZATION FOR MINIMIZING EMISSIONS

(76) Inventors: Mark Leonard Cooper, Felton, CA (US); Stephen Solomon Altus, Campbell, CA (US)

Correspondence Address: DUKE W. YEE, YEE & ASSOCIATES, P.C., P.O. BOX 802333, DALLAS, TX, 75380, US

(21) Appl. No.: 12/030,553

(22) Filed: Feb. 13, 2008

(51) Int. Cl. G06Q 99/00

(52) U.S. Cl. 705/7

(57) ABSTRACT

A computer implemented method, apparatus, and computer program product for performing flight planning to reduce an effect of emissions. A method is present for performing flight planning. A set of emissions data is identified for an aircraft for a plurality of route segments in a route as a function of parameters for the aircraft including the route, a weight, an altitude, and engine data. A flight plan is generated for the aircraft based on a total of each type of emission in the set of emissions data from the plurality of route segments. A portion of the parameters for the aircraft is modified to reduce the effect of the emissions and meet a set of objects for the flight plan until the flight plan meets an objective.

### BACKGROUND INFORMATION

1. Field

The present disclosure relates generally to aircraft emissions and in particular to a method and apparatus for minimizing aircraft emissions. Still more particularly, the present disclosure relates to a method, apparatus, and computer usable program code for optimizing flight plans for aircraft to minimize emissions.

2. Background

Aircraft engines generate emissions similar to those occurring with internal combustion engines used in automobiles. Aircraft can make similar amounts of noise pollution and air pollution emissions. A significant portion of aircraft emissions are usually emitted at high altitudes. With the concerns of ozone layer depletion and climatic changes, the effect of these aircraft emissions has become a worldwide concern with respect to air quality and climate change. Aircraft emissions typically include carbon dioxide (CO₂), water vapor (H₂0), nitric oxide (NO), nitrogen dioxide (NO₂), sulfur oxide (SO₂), and particulate matter. Nitric oxide and nitrogen oxide are also collectively referred to as NOₓ or nitrogen.

Aircraft manufacturers are focusing on producing an aircraft with reduced emissions. Currently, aircraft are required to meet engine certification standards that have limits for the emission of nitrogen (NOₓ), carbon monoxide, and other hydrocarbons. Nitrogen is a particular concern because this component is a precursor for ozone. At the altitudes that aircraft fly, this emission acts as a greenhouse gas. Aircraft manufacturers are producing engines with lower levels of nitrogen emissions as well as improving other emissions. The lower emissions, in many cases, are still of concern with respect to their effect on the atmosphere.

Advances in producing aircraft that have reduced emissions may take many years to deploy. Therefore, it would be advantageous to have a method and apparatus to reduce the impact to the atmosphere from existing worldwide air fleet.

### SUMMARY

The advantageous embodiments provide a computer implemented method, apparatus, and computer program product for performing flight planning to reduce an effect of emissions. In one advantageous embodiment, a method is present for performing flight planning. A set of emissions data is identified for an aircraft for a plurality of route segments in a route as a function of parameters for the aircraft including the route, a weight, an altitude, and engine data. A flight plan is generated for the aircraft including a report of a total of each type of emission in the set of emissions data from the plurality of route segments. A portion of the parameters for the aircraft is modified to reduce the effect of the emissions and meet a set of objects for the flight plan until the flight plan meets an objective.

In another advantageous embodiment, a computer implemented method is present for performing flight planning to reduce an effect of emissions on an atmosphere. The effect on the atmosphere is identified as a function of a set of parameters for a proposed flight plan for an aircraft. A determination is made as to whether an effect of the emissions on the atmosphere is acceptable. Responsive to a determination that the effect on the atmosphere is unacceptable, the set of parameters are modified until the effect on the atmosphere is more favorable.

In a different advantageous embodiment, a computer program product is present for performing flight planning to reduce an effect of emissions on an atmosphere, the computer program product comprises computer readable media and program code. Program code is present for identifying the effect on the atmosphere as a function of a set of parameters for a proposed flight plan for an aircraft. The computer program product also has program code for determining whether the effect of the emissions on the atmosphere is acceptable. Program code is present, responsive to a determination that the effect on the atmosphere is unacceptable, for modifying the set of parameters until the effect on the atmosphere is acceptable.

In yet another advantageous embodiment, a data processing system comprises a bus, a storage device connected to the bus, and a processor unit connected to the bus. Computer readable program code is stored on the storage device. The processor unit executes the computer readable program code to identify an effect on the atmosphere as a function of a set of parameters for a proposed flight plan for an aircraft; determine whether the effect of the emissions on the atmosphere is acceptable; and modify the set of parameters until the effect on the atmosphere is acceptable in response to a determination that the effect on the atmosphere is unacceptable.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives and advantages thereof, will best be understood by reference to the following detailed description of an advantageous embodiment of the present disclosure when read in conjunction with the accompanying drawings, wherein:

FIG. 1 is a pictorial representation of a network of data processing systems in which the advantageous embodiments may be implemented;

FIG. 2 is a diagram of a data processing system in accordance with an illustrative embodiment;

FIG. 3 is a diagram of a flight planning system in accordance with an advantageous embodiment;

FIG. 4 is a block diagram of an optimizer in accordance with an advantageous embodiment;

FIG. 5 is a diagram illustrating an analysis process in accordance with an advantageous embodiment;

FIG. 6 is a diagram illustrating a selection of points and segments for identifying the impact of emissions in accordance with an advantageous embodiment;

FIG. 7 is a flowchart of a process for performing flight planning in a manner that reduces the effect of emissions in the atmosphere in accordance with an advantageous embodiment; and

FIG. 8 is a flowchart of a process for performing flight planning to reduce the effect of emissions on the atmosphere in accordance with an advantageous embodiment.

### DETAILED DESCRIPTION

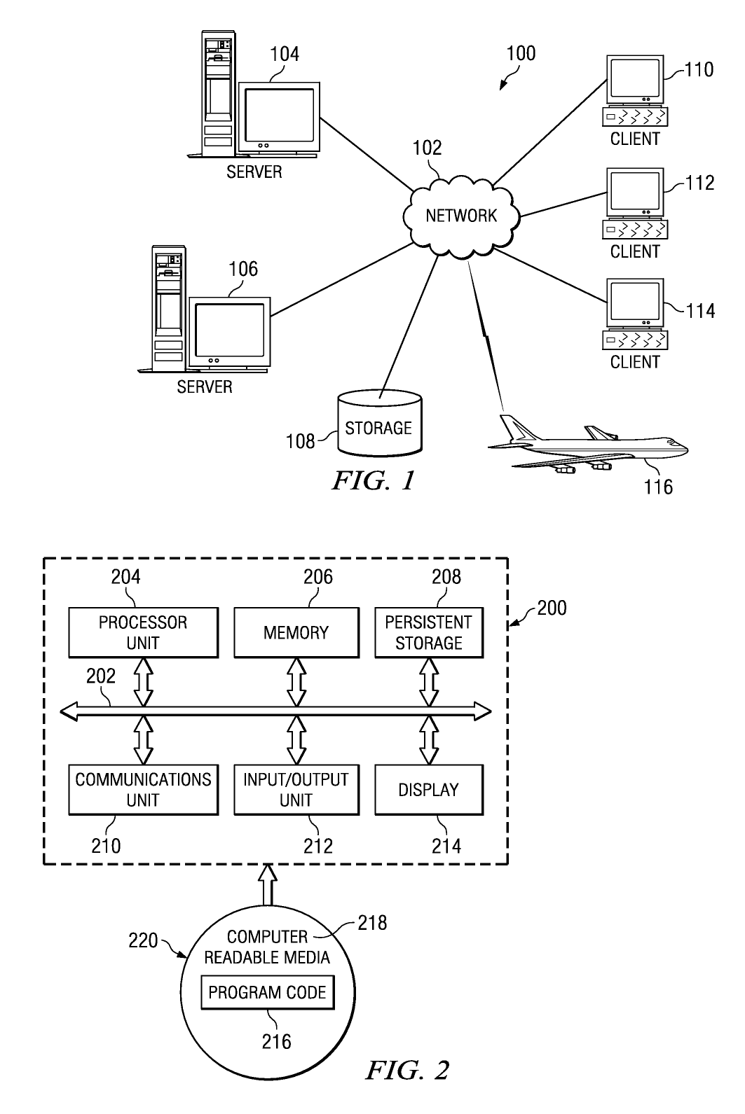

With reference now to the figures and in particular with reference to FIGS. 1-2, exemplary diagrams of data processing environments are provided in which the advantageous embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to FIG. 1, a pictorial representation of a network of data processing systems is depicted in which the advantageous embodiments may be implemented. Network data processing system 100 is a network of computers in which embodiments may be implemented. Network data processing system 100 contains network 102, which is the medium used to provide communications links between various devices and computers connected together within network data processing system 100.

Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Aircraft 116 also is a client that may exchange information with clients 110, 112, and 114. Aircraft 116 also may exchange information with servers 104 and 106. Aircraft 116 may exchange data with different computers through a wireless communications link while in-flight or any other type of communications link while on the ground. In these examples, server 104, server 106, client 110, client 112, and client 114 may be computers. Network data processing system 100 may include additional servers, clients, and other devices not shown.

In these illustrative examples, network data processing system 100 may be used to perform flight planning in a manner that reduces or minimizes the effect of emissions on the atmosphere. This reduction on the effect may include reducing emissions or changing the altitudes where emissions occur. In the advantageous embodiments, a flight planning system may be implemented to generate a flight plan for aircraft 116. Further, the flight planning processes in the advantageous embodiments also may be used dynamically during flight of aircraft 116 to make changes in the flight plan for aircraft 116.

In the depicted example, network data processing system 100 is the Internet with network 102 representing a worldwide collection of networks and gateways that use the Transmission Control Protocol/Internet Protocol (TCP/IP) suite of protocols to communicate with one another. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

Turning now to FIG. 2, a diagram of a data processing system is depicted in accordance with an illustrative embodiment. Data processing system 200 is an example of a data processing system that may be used to implement servers and clients, such as server 104 and client 110. Further, data processing system 200 is an example of a data processing system that may be found in aircraft 116 in FIG. 1.

In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

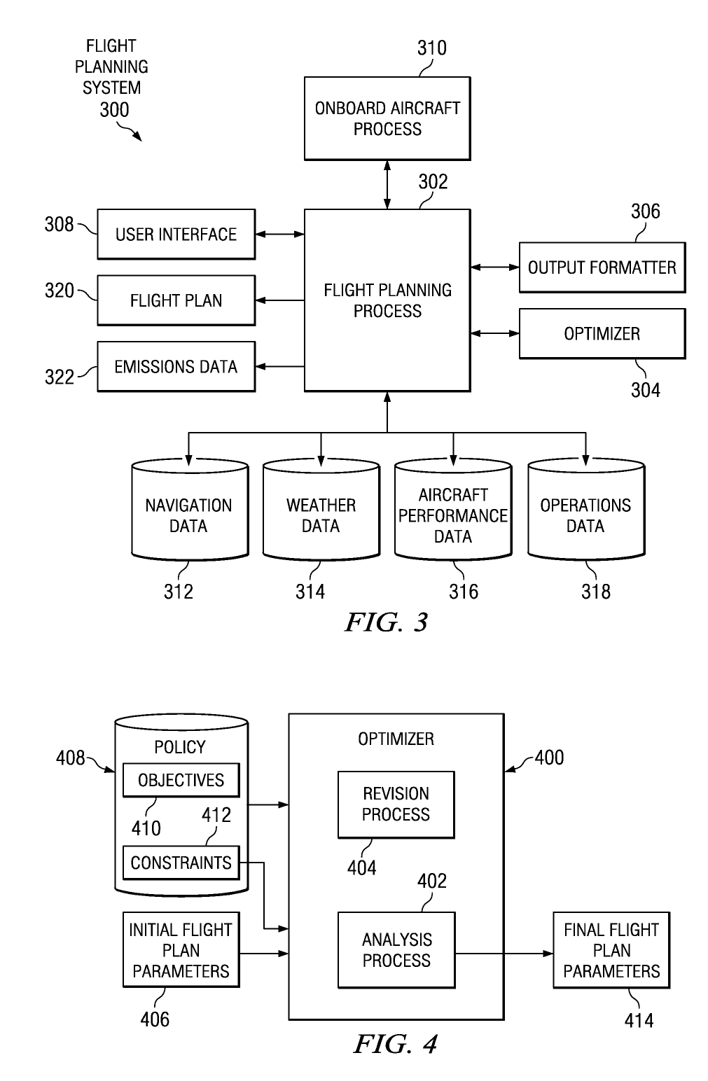

With reference now to FIG. 3, a diagram of a flight planning system is depicted in accordance with an advantageous embodiment. In this example, flight planning system 300 includes flight planning process 302, optimizer 304, output formatter 306, user interface 308, onboard aircraft process 310, navigation data 312, weather data 314, aircraft performance data 316, and operations data 318.

In these examples, flight planning system 300 may be implemented using network data processing system 100 in FIG. 1. For example, onboard aircraft process 310 may be located in aircraft 116 in FIG. 1. Flight planning process 302 may be located on server 104 in FIG. 1. Optimizer 304 and output formatter 306 also may be located on server 104 in FIG. 1. In other embodiments, these components may be distributed across other data processing systems, such as server 106 with client 110 in FIG. 1. User interface 308 may be located on server 104 in FIG. 1 or on a client, such as client 112 in FIG. 1. The data may be located on server 104 or distributed in different locations within network 100, such as on storage 108 and/or server 106 in FIG. 1.

Flight planning process 302 generates flight plan 320 using data from navigation data 312, weather data 314, aircraft performance data 316, and operations data 318. In these examples, navigation data 312 may come from various sources. Navigation data 312 may be, for example, charts and/or map information describing airways, named waypoints, or terrain over which an aircraft may fly. Navigation data 312 may be obtained from one or more sources in various formats.

Weather data 314 contains weather information that may be used for flight planning. This data may be static or dynamic data. Static data is historical data that has been collected for past times. Dynamic data, in these examples, is current data, real time data, or forecast data. An example of dynamic weather data is data obtained from a real time satellite feed.

Aircraft performance data 316 includes information about aircraft in models. This information describes how those aircraft perform under certain conditions. This information typically includes information about fuel usage, speed, rate of climb, and altitude values for an aircraft. The information in these examples also includes, for example, information about emissions that aircraft generate. This information may be used to identify or calculate emissions generated by an aircraft at different speeds and altitudes. Further, the weather also may change the effect of the emissions calculated in these examples.

Operations data 318 contains data about the operation of various aircraft. This data may include, for example, cost model, regulations, policies, and other information related to the operation of an aircraft. Optimizer 304 may include processes to optimize flight plan 320.

Flight plan 320 is created during a planning process and is followed by an aircraft during flight from a departure point to a destination point. Flight plan 320 is typically required to be filed with the appropriate authorities prior the aircraft actually flying from the departure point to the destination point. Various aspects of a flight plan may include, for example, fuel calculations and compliance with air traffic control requirements. Correct fuel calculations ensure that the aircraft can safely reach the destination. Compliance with air traffic control requirements minimizes the risk of midair collisions. Other risks that may be minimized by flight plan 320 include running out of fuel, weather conditions, or other condition requiring a divert, dictate an alternate route. Other considerations that may be taken into account in flight plan 320 include, for example, minimizing costs by appropriate choice of route, altitudes, speed, and loading minimum fuel required, including a reserve amount, as well as other considerations.

In the advantageous embodiments, flight plans 320 may be optimized to reduce the effect of emissions on the atmosphere. For example, the effect of emissions may be reduced by actually reducing the emissions generated by the aircraft and/or generating emissions in a location that reduces the effect of the emissions on the atmosphere. In one example, the speed of the aircraft may be selected to reduce the emissions. Alternatively, the altitudes of the aircraft may be changed. Flying at a low altitude may not change the schedule, but may reduce the impact of emissions generated by the aircraft. This optimization may not be the lowest amount of emissions or the least effect on the atmosphere possible. For example, the emissions may be the lowest level or lowest effective emissions for a particular route, or time traveled.

Output formatter 306 generates an output for flight plan 320. Output formatter 306 arranges data from the flight plan calculations performed by flight planning process 302 into a human readable format. This format may be designed or defined by a user, such as an airline. This data may include, for example, a summary of all routing, altitudes, weight, fuel, and time data as calculated by flight planning processing 302.

In some advantageous embodiments, output formatter 306 may not output flight plan 320. Instead, output formatter 306 may output emissions data 322. This data may be in the form of a report and may contain the emissions predicted to be generated by the aircraft for a particular flight to be flown. This emissions data may, for example, contain the total emission for the entire flight. Additionally, emissions data 322 also may include the emissions generated for different portions or segments of the route over which the aircraft flies as well as each type of emission that may be present in the emissions. This type of data may be used to identify a carbon tax for the flight.

User interface 308 may be used to create and view flight plan 320. Flight plan 320 may be transmitted to onboard aircraft process 310 for use. This flight plan may be used to generate routes for all of the pilot systems and/or display information to the flight crew.

In addition to identifying the most favorable parameters that may be used to minimize the effect of emissions on the atmosphere, flight planning system 300 also may be used to evaluate different aircraft for a particular flight. For example, the parameters of flight plan 320 may stay constant while models for different aircraft are selected from aircraft performance data 316 to calculate the emissions that may be generated for each aircraft for flight plan 320 with the same parameters. In other embodiments, both the aircraft and parameters in flight plan 320 may be varied.

Also, the identification of emissions may be used to identify the tax that may be added to the flight. Some countries, states, cities, or other authority may apply a tax such as an emissions tax or carbon tax. This type of tax is based on the amount of emissions generated by a flight flown by an aircraft. This cost may also be referred to as an emission off set cost.

Different components illustrated in flight planning system 300 are provided for purposes of depicting one embodiment. Other advantageous embodiments may include other components in addition to the ones illustrated in these examples. This illustration is not meant to limit the manner in which different advantageous embodiments may be implemented. These components are illustrations of functional components, which may be implemented on different hardware systems.

For example, one or more of the components may be implemented on the same or different data processing system. As another example, navigation data 312, weather data 314, aircraft performance data 316, and operation data 318 may be located on the same data processing system or on different data processing systems or sources.

Turning now to FIG. 4, a block diagram of an optimizer is depicted in accordance with an advantageous embodiment. In this example, optimizer 400 is a more detailed example of optimizer 304 in FIG. 3. Optimizer 400 contains one or more processes that may be used to optimize a flight plan to reduce the effect of emissions generated by an aircraft on the atmosphere. As depicted, optimizer 400 includes analysis process 402 and revision process 404.

Analysis process 402 receives initial flight plan parameters 406 for analysis. Initial flight plan parameters 406 may be received from a flight planning process, such as flight planning process 302 in FIG. 3. These parameters may include, for example, an initial estimate of the route, altitudes, departure time, cargo, weight, and other factors that may change the performance of the aircraft, the effect of emissions generated by the aircraft, and other suitable parameters. In these examples, optimization may mean that the lowest effect of emissions may be identified in a manner that takes into account other factors.

For example, in reducing emissions, a selected time of arrival or en route time may be required for the aircraft. The emissions may be optimized to generate the lowest effect of the emissions. As a result, emissions may not be as low as compared to a flight plan that does not take into account or give weight or priority to other factors other than minimizing the effect of the emissions. In this manner, the method, apparatus, and computer usable program product in the different advantageous embodiments may be used to optimize or otherwise manage the flight plan of an aircraft.

Analysis process 402 may analyze initial flight plan parameters 406 with respect to policy 408. Policy 408 is a set of rules and/or parameters that may be used to determine other changes that are needed to initial flight plan parameters 406. In these examples, policy 408 includes objectives 410 and constraints 412. Objectives 410 may include, for example, a selected level of emissions for a selected level of effect of the emissions. Constraints 412 may include various factors, such as, for example, a departure time, an arrival time, an amount of fuel used, en route time, or some other suitable factor. The objective may be, for example, identifying a set of parameters that provides a more favorable effect on the atmosphere as compared to the initial set of parameters.

In another example, policy 408 may be a rule that states the parameters are modified until the effect on the atmosphere is less than that caused by initial flight plan parameters 406. In other words, the effect on the atmosphere is more favorable. A more favorable effect means that the effect of the emissions on the atmosphere is less than those with initial flight plan parameters 406. Regardless of whether specific emissions levels are targeted as a threshold or whether identifying a lower effect of emissions without a particular target level or threshold, these modifications of initial flight plan parameters 406 generates a set of parameters that have an effect that is more favorable than initial flight plan parameters 406.

If initial flight plan parameters 406 meet policy 408 after analysis, initial flight plan parameters 406 becomes final flight plan parameters 414. On the other hand, if initial flight plan parameters 406 do not meet policy 408, then initial flight plan parameters 406 are adjusted using revision process 404. Revision process 404 may change various parameters within initial flight plan parameters 406 in a manner that reduces the effect of emissions. Revision process 404 may use objectives 410 and constraints 412 in making changes to initial flight plan parameters 406. After changes have been made to initial flight plan parameters 406, these revisions are analyzed by analysis process 402. Once the flight plan parameters meet policy 408, final flight plan parameters 414 are generated.

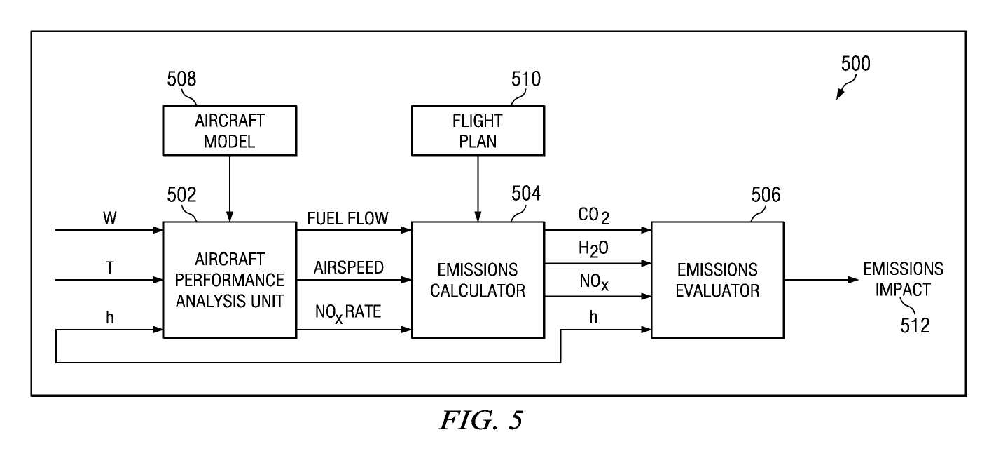

Turning now to FIG. 5, a diagram illustrating an analysis process is depicted in accordance with an advantageous embodiment. In this example, optimizer 500 includes aircraft performance analysis unit 502, emissions calculator 504, and emission evaluator 506. Aircraft performance analysis unit 502 receives aircraft model 508 and input parameters, such as, for example, aircraft weight, W, temperature deviation, T, and altitude, h. In these examples, aircraft model 508 is an example of an aircraft model that may be found in aircraft performance data 316 in FIG. 3.

The input parameters are analyzed by aircraft performance analysis unit 502 to generate output parameters, such as, for example, fuel flow, air speed, and NOₓ rate. These input parameters are only examples. Any other input parameters may be used in these examples. These output parameters are input into emissions calculator 504 along with flight plan 510 to identify various emissions that may be generated by the aircraft in aircraft model 508. These emissions include, for example, carbon dioxide, water, and nitrogen. Emissions evaluator 506 evaluates the impact of these emissions for the altitudes at which the aircraft may fly. The output is emissions impact 512. This impact may be compared with various objectives to determine whether changes may be needed to the flight plan. If changes are made, these changes may then be analyzed by aircraft performance analysis process unit 502 to generate new emission impacts.

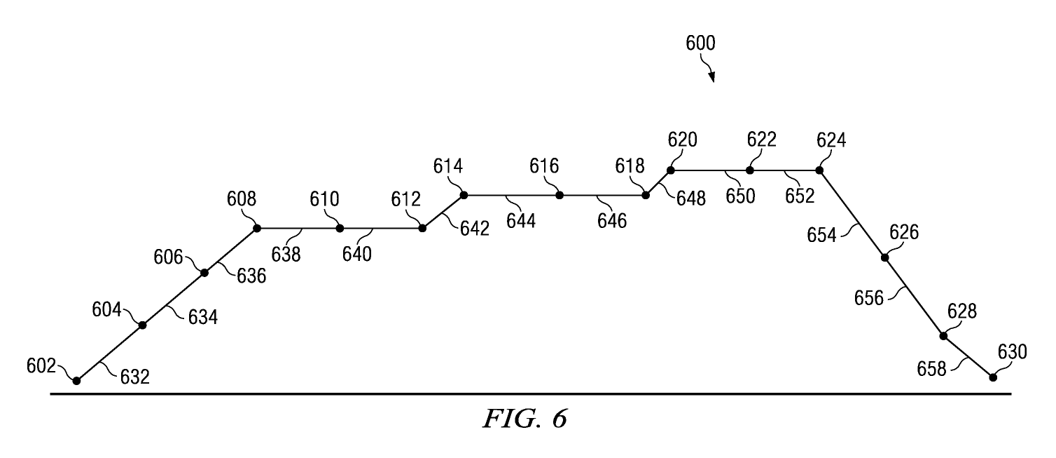

Turning now to FIG. 6, a diagram illustrating a selection of points and segments for identifying the impact of emissions is depicted in accordance with an advantageous embodiment. In this example, route 600 is a route of an aircraft as a function of altitude from departure point 602 to destination point 630. Route 600 is an example of an initial flight parameter that may be initial flight plan parameters 406 in FIG. 4. In these examples, the emissions are calculated over route 600 as a function of weight, route, altitude, and speed. At each point, emissions are calculated for carbon monoxide, carbon dioxide, nitrogen, and unburned hydrocarbons.

In these examples, the amount of emissions and the impact of those emissions are calculated for different altitudes along route 600. In these examples, the impact of emissions is calculated at points 604, 606, 608, 610, 612, 614, 616, 618, 620, 622, 624, 626, and 628. Between these points are segments 632, 634, 636, 638, 640, 642, 644, 646, 648, 650, 652, 654, 656, and 658. These segments may be selected to have different lengths depending on the particular implementation. One or more segments within route 600 may be part of different phases of a flight. For example, one or more segments may be part of a take-off phase, a landing phase, a climb phase, a cruise phase, an approach phase, and a taxiing phase.

Each segment has an emissions impact on the atmosphere. The emissions for a particular segment may be calculated in a number of different ways. For example, the emissions impact for a segment may be the average between two points. As another example, the emissions for the initial point and the final point may be used to perform a nonlinear approximation. In another example, the identification of the emissions may be made by subdividing the segment into smaller segments and the total emissions may be numerically integrated with the smaller segments.

In this manner, the route of an aircraft may be broken down into different segments in which emissions are calculated for each segment with the totals being summed to identify the total impact of the flight plan. The impact of each type of emission in the emissions data may be identified by summing the emissions impact for each segment.

In other words, route 600 may have different types of emissions impact on the atmosphere depending on the analysis being made. For example, the type of emissions data that may be identified for each segment in sum as a whole may include, for example, the amount of carbon dioxide, the amount of carbon monoxide, particulate matter emitted, volatile organic compounds, nitrogen oxide, and nitrogen dioxide.

Using this information, the flight plan may be changed or altered to reduce the impact of emissions by changing altitudes at various segments as long as the new altitudes meet various constraints with respect to the flight planning, such as required minimum altitudes over various geographic areas. Further, the speed at each one of these points also may be used to determine the emissions as well as altering speeds to change the emissions.

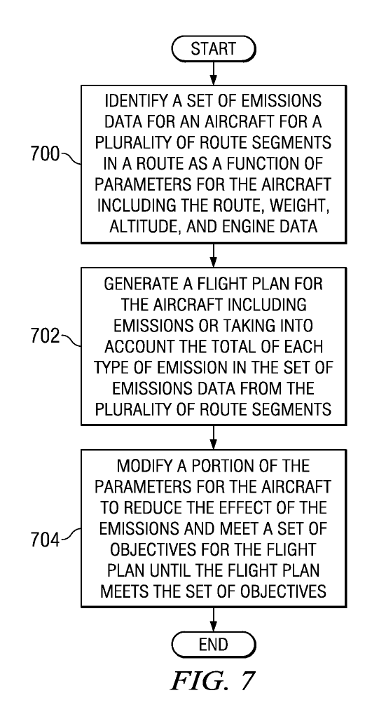

Turning now to FIG. 7, a flowchart of a process for performing flight planning in a manner that reduces the effect of emissions in the atmosphere is depicted in accordance with an advantageous embodiment. The process illustrated in FIG. 7 may be implemented in a process, such as optimizer 400 in FIG. 4.

The process begins by identifying a set of emissions data for an aircraft for a plurality of route segments in a route as a function of parameters for the aircraft including the route, weight, altitudes, and engine data (operation 700). The set of emissions data may refer to different types of emissions. These emissions may include, for example, carbon monoxide, carbon dioxide, particulate matter, volatile organic chemicals, nitrogen oxide, and nitrogen dioxide. The parameters for the aircraft also may include other parameters, such as, for example, speed of the aircraft over the route and weather.

Of course, any parameters suitable for identifying emissions generated by the aircraft may be used. Further, emissions data also may take into account the effect of the emissions in the atmosphere based on parameters including, for example, altitudes, temperature, and other weather conditions.

The process then generates a flight plan for the aircraft including emissions or taking into account the total of each type of emission in the set of emissions data from the plurality of route segments (operation 702). In operation 702, the flight plan may include the total of each type of emission in the set of emissions data from the route segments. This operation identifies the total emissions generated by the aircraft. Further, the emissions data also may include the effect on the atmosphere in addition to the emissions itself. For example, the same type of emissions at one altitude may have a different effect on the atmosphere as compared to another altitude. As a result, this type of difference and its effect on the atmosphere may be given different weights for use in evaluating the impact of the emissions.

The process then modifies a portion of the parameters for the aircraft to reduce the effect of the emissions and meet a set of objectives for the flight plan until the flight plan meets the set of objectives (operation 704). In operation 704, these modifications may be made iteratively until the objectives are met. The set of objectives is one or more objectives and may include, for example, a desired level of emissions from the aircraft. The set of objectives also may include other objectives, such as, for example, a selected en route time, a particular arrival time, a desired speed, a minimum altitude, a maximum altitude, and/or some other suitable parameter.

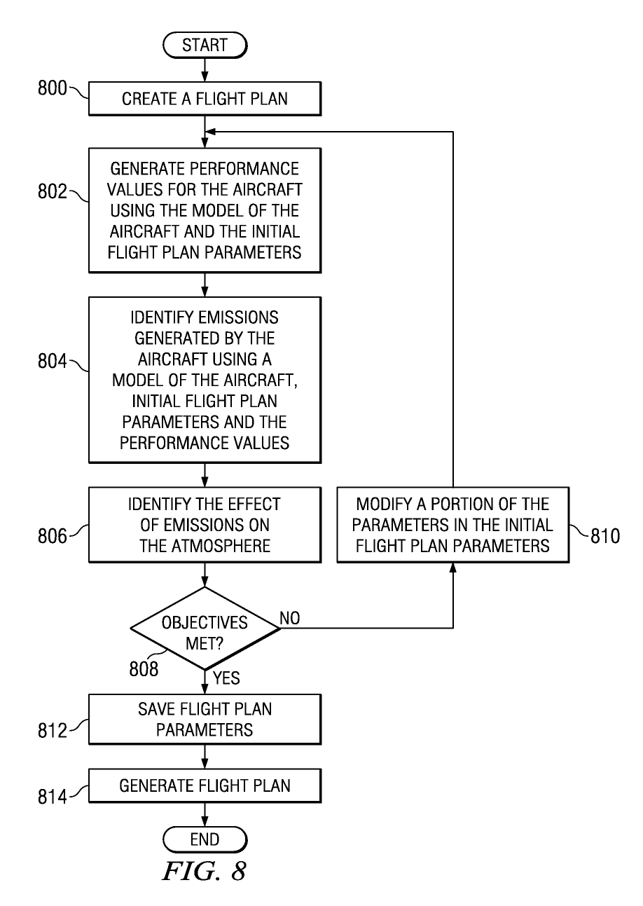

Turning now to FIG. 8, a flowchart of a process for performing flight planning to reduce the effect of emissions on the atmosphere is depicted in accordance with an advantageous embodiment. The process illustrated in FIG. 8 may be implemented in a software component, such as optimizer 400 in FIG. 4.

The process begins by creating a flight plan (operation 800). The flight plan includes initial flight plan parameters. Performance values for the aircraft are generated using the model of the aircraft and the initial flight plan parameters (operation 802). Thereafter, the process identifies emissions generated by the aircraft using the initial flight plan parameters, a model of the aircraft, and the performance values generated (operation 804).

The process then identifies the effect of the emissions on the atmosphere (operation 806). This effect is identified by comparing the emissions generated with other factors and considerations. For example, the same emissions may have more effect on the atmosphere at a higher altitude than a lower altitude. In another example, aircraft engines may produce different amounts of NOₓ as a fraction of fuel flow based on combustion temperature. The combustion temperature depends on the thrust required for the current weight, temperature, altitudes, speed, comparison of the combustion temperature to the design point of the engine, and other suitable factors.

Thereafter, a determination is made as to whether objectives are met by the effect of the emissions and the initial flight plan parameters (operation 808). These objectives include the effect of the emissions on the atmosphere. The objectives also may include, for example, a minimum speed, a minimum altitude, a maximum altitude, an en route time, an arrival time, the route, and other suitable parameters.

If the objectives are not met, the process modifies a portion of the parameters in the initial flight plan parameters (operation 810). The process then returns to operation 802 as described above. The portion of the parameters in the initial flight plan parameters may be one or more parameters. The amount of modification of the parameters in the particular parameters modified may vary depending on the objectives set for the flight plan.

For example, the speed of the aircraft may only be reduced to a certain extent depending on the minimum speeds set by the objectives. Further, the minimum speed may be set based on the en route time or the arrival time set in the objectives. Of course, the particular parameters modified in the amount of modifications will vary depending on the particular objective and implementation. This process is iterative and loops back through steps 802, 804, 806, and 808 until the objectives are met.

With reference again to operation 808, when the objectives are met, the final flight plan parameters are saved (operation 812). Thereafter, the flight plan is generated (operation 814). The process terminates thereafter.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of computer usable or readable program code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the different advantageous embodiments provide a computer implemented method, apparatus, and computer useable program code for performing flight planning. The flight planning in these advantageous embodiments is performed in a manner that reduces the emissions and/or the effect of emissions on the atmosphere. In the different advantageous embodiments, a set of emissions for an aircraft is identified for a particular flight plan. A determination is made as to whether the effect of the emissions meets a set of objectives based on the current flight plan. If the emissions do not meet the objectives, a portion of the parameters in the flight plan may be modified with the identification of the effect of the emissions being made with the modified parameters. This modification of the parameters may occur iteratively until the objective for the emissions, as well as possibly other objectives, is met.

The different advantageous embodiments can take the form of an entirely hardware embodiment, an entirely software embodiment, or an embodiment containing both hardware and software elements. Some embodiments are implemented in software, which includes but is not limited to forms, such as, for example, firmware, resident software, and microcode.

Furthermore, the different embodiments can take the form of a computer program product accessible from a computer-usable or computer-readable medium providing program code for use by or in connection with a computer or any device or system that executes instructions. For the purposes of this disclosure, a computer-usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non limiting examples of a computer-readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W) and DVD.

Further, a computer-usable or computer-readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example without limitation, physical or wireless.

A data processing system suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories which provide temporary storage of at least some computer readable or computer usable program code to reduce the number of times code may be retrieved from bulk storage during execution of the code.

Input/output or I/O devices can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems or remote printers or storage devices through intervening private or public networks. Non-limiting examples are modems and network adapters are just a few of the currently available types of communications adapters.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for performing flight planning to reduce an effect of emissions, the method comprising:
calculating a set of emissions data for an aircraft for a plurality of route segments in a route as a function of parameters for the flight plan including the route, a weight, an altitude, and engine data;
generating a flight plan for the aircraft taking into account a total of each type of emission in the set of emissions data from the plurality of route segments; and
modifying a portion of the parameters for the flight plan to reduce the effect of the emissions and meet a set of objects for the flight plan until the flight plan meets an objective.

2. The method of claim 1, wherein the plurality of route segments comprises a take-off phase, an approach phase, a landing phase, a climb phase, a cruise phase, and a taxiing phase.

3. The method of claim 1, wherein the set of emissions data comprises carbon monoxide, carbon dioxide, particulate matter, volatile organic compounds, nitrogen oxide, and nitrogen dioxide.

4. The method of claim 1, wherein the objective includes an emission offset cost.

5. A computer implemented method for performing flight planning to reduce an effect of emissions on an atmosphere, the computer implemented method comprising:
identifying the effect on the atmosphere as a function of a set of parameters for a proposed flight plan for an aircraft;
determining whether the effect of the emissions on the atmosphere is acceptable; and
responsive to a determination that the effect on the atmosphere is unacceptable, modifying the set of parameters until the effect on the atmosphere is more favorable.

6. The computer implemented method of claim 5, wherein the identifying step comprises:
generating performance values for the aircraft for a plurality of segments in a route for the proposed flight plan using the set of parameters; and
identifying the emissions generated by the aircraft for the plurality of segments using the performance values and a model of the aircraft.

7. The computer implemented method of claim 5, wherein the determining step comprises:
determining whether an amount of each type of the emissions identified for the aircraft using the proposed flight plan is greater than a threshold level.

8. The computer implemented method of claim 5, wherein the determining step comprises:
determining whether an amount of each type of the emissions identified for the aircraft using the proposed flight plan is greater than a threshold level with respect to a set of altitudes at which the amount of the each type of the emissions is identified.

9. The computer implemented method of claim 8, wherein the each type of the emissions comprises at least one of carbon monoxide, carbon dioxide, particulate matter, volatile organic compounds, nitrogen oxide, and nitrogen dioxide.

10. The computer implemented method of claim 5, wherein the modifying step comprises:
changing the set of parameters to reduce the effect of the emissions on the atmosphere.

11. The computer implemented method of claim 10, wherein the changing step comprises:
changing the set of parameters to reduce an amount of the emissions generated by the aircraft.

12. The computer implemented method of claim 10, wherein the changing step comprises:
changing an altitude of the aircraft over a portion of the route.

13. The computer implemented method of claim 10, wherein the changing step comprises:
changing the set of parameters to reduce an amount of the emissions generated by the aircraft while meeting a set of constraints for the proposed flight plan.

14. The computer implemented method of claim 5, wherein the set of parameters comprises an aircraft.

15. A computer implemented method for identifying flight costs for an aircraft, the computer implemented method comprising:
identifying an amount of emissions using a set of parameters for a proposed flight plan and a model of the aircraft, wherein the amount of emissions include a total of each type of emission present in the amount of emissions; and
generating a report containing the amount of emissions.

16. The computer implemented method of claim 15 further comprising:
calculating a tax for the amount of emissions.

17. A computer program product for performing flight planning to reduce an effect of emissions on an atmosphere, the computer program product comprising:
computer readable media;
program code for identifying the effect on the atmosphere as a function of a set of parameters for a proposed flight plan for an aircraft;
program code for determining whether the effect of the emissions on the atmosphere is more favorable; and
program code, responsive to a determination that the effect on the atmosphere is unacceptable, for modifying the set of parameters until the effect on the atmosphere is acceptable.

18. The computer program product claim 17, wherein the program code for identifying the effect on the atmosphere as the function of the set of parameters for the proposed flight plan for the aircraft comprises:
program code for generating performance values for the aircraft for a plurality of segments in a route for the proposed flight plan using the set of flight plan parameters; and
program code for identifying the emissions generated by the aircraft for the plurality of segments using the performance values and a model of the aircraft.

19. The computer program product of claim 17, wherein the program code for determining whether the effect of the emissions on the atmosphere is acceptable comprises:
program code for determining whether an amount of each type of the emissions identified for the aircraft using the proposed flight plan is greater than a threshold level.

20. The computer program product of claim 17, wherein the program code for determining whether an effect of the emissions on the atmosphere is acceptable comprises:
program code for determining whether an amount of each type of emissions identified for the aircraft using the flight plan is greater than a threshold level with respect to a set of altitudes at which the amount of each type of emissions is identified.

21. The computer program product of claim 17, wherein the program code, responsive to a determination that the effect on the atmosphere is unacceptable, for modifying the set of parameters until the effect on the atmosphere is acceptable comprises:
program code for changing the set of parameters to reduce the effect of the emissions on the atmosphere.
